(19) United States
(12) Patent Application Publication
(10) Pub. No.: US 2015/0173550 A1
(43) Pub. Date: Jun. 25, 2015

(54) Household Electrothermal Vaporization Heater

(71) Applicant: Yao-Tsung Kao, Tainan City (TW)

(72) Inventor: Yao-Tsung Kao, Tainan City (TW)

(21) Appl. No.: 14/133,872

(22) Filed: Dec. 19, 2013

(51) Int. Cl. A47J 27/04; A47J 27/00

(52) U.S. Cl. CPC A47J 27/04; A47J 27/004; A47J 2027/043

(57) ABSTRACT

A household electrothermal vaporization heater contains a heating body and a cover. The heating body includes a heat tube precast therein and made of thermal conductivity material and a heating channel corresponding to the heat tube and formed in a U shape. The heating channel has an inlet defined on a first end thereof so as to pour liquid water, such that the liquid water flows in the heating channel and is heated by the heat tube quickly so as to convert into superheated steams, and the cover covers and screws with the heating channel by using a plurality of screw elements, thus preventing steams from leakage. The cover includes a plurality of vapor orifices formed on end edges thereof and corresponding to a second end of the heating channel so as to spray the superheated steams.

### FIELD OF THE INVENTION

The present invention relates to a household electrothermal vaporization heater which is capable of converting liquid water into superheated steams so as to cook/steam food material quickly by spraying the superheated steams onto food material at over 300° C.

### BACKGROUND OF THE INVENTION

Conventional cooking utensils, such as rice cooker, soup pot, kettle, and oven, are applied to cook food material, wherein the rice cooker is commonly used to cook the food material. For example, the food material is placed in the rice cooker and is heated by a bottom end of the rice cooker. However, such a heating speed is quite slow.

Furthermore, after cooking the food material, the rice cooker enters a heat preservation state, so rice or the food material in the rice cooker is dry and becomes tough after a period of heat preserving time, thus influencing original flavor of the rice or the food material.

During making soup, the soup is continuously heated after it is boiled, accordingly it becomes turbid and its original flavor vanishes.

The present invention has arisen to mitigate and/or obviate the afore-described disadvantages.

### SUMMARY OF THE INVENTION

The primary object of the present invention is to provide a household electrothermal vaporization heater which is capable of converting liquid water into superheated steams so as to cook/steam food material quickly by spraying the superheated steams onto food material at over 300° C.

Another object of the present invention is to provide a household electrothermal vaporization heater which is applicable for various cooking utensils, such as rice cooker, soup pot, kettle, and oven, etc.

### BRIEF DESCRIPTION OF THE DRAWINGS

FIG. 1 is a flow chart showing the operation of a household electrothermal vaporization heater according to a preferred embodiment of the present invention.

FIG. 2 is a perspective view showing the exploded components of the household electrothermal vaporization heater according to the preferred embodiment of the present invention.

FIG. 3 is a perspective view showing the assembly of the household electrothermal vaporization heater according to the preferred embodiment of the present invention.

FIG. 4 is a cross sectional view showing the operation of the household electrothermal vaporization heater according to the preferred embodiment of the present invention.

FIG. 5 is another cross sectional view showing the operation of the household electrothermal vaporization heater according to the preferred embodiment of the present invention.

FIG. 6 is a perspective view showing the application of the household electrothermal vaporization heater according to the preferred embodiment of the present invention.

FIG. 7 is a cross sectional view showing the application of the household electrothermal vaporization heater according to the preferred embodiment of the present invention.

FIG. 8 is another cross sectional view showing the application of the household electrothermal vaporization heater according to the preferred embodiment of the present invention.

FIG. 9 is also another cross sectional view showing the application of the household electrothermal vaporization heater according to the preferred embodiment of the present invention.

FIG. 10 is still another cross sectional view showing the application of the household electrothermal vaporization heater according to the preferred embodiment of the present invention.

### DETAILED DESCRIPTION OF THE PREFERRED EMBODIMENTS

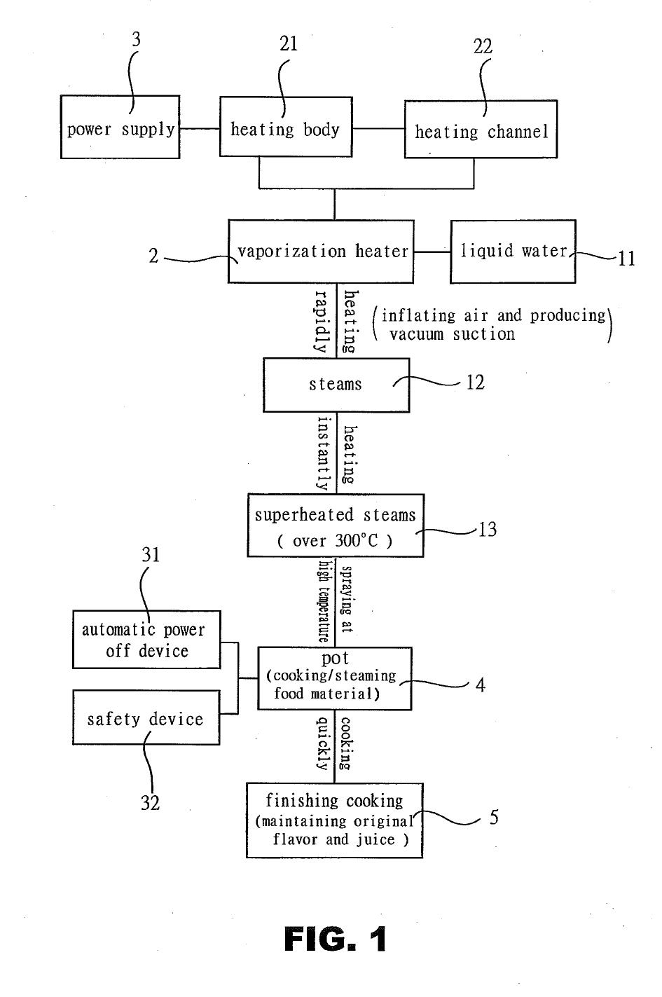

FIG. 1 is a flow chart showing the operation of a household electrothermal vaporization heater according to a preferred embodiment of the present invention. The household electrothermal vaporization heater 2 of the present invention is used to draw liquid water 11 and comprises a heating body 21 and a cover 23. After starting a power supply, the vaporization heater 2 generates a heat rapidly so as to heat the liquid water 11, thus producing steams 12. Thereafter, the steams 12 are circulated to generate superheated steams 13, meanwhile, a temperature of the superheated steams 13 is more than 300 ° C., and the superheated steams 13 are sprayed out of a pot 4 to cook (steam) food material or soup, thus finishing cooking 5. To maintain original flavor of the food material, the pot 4 includes an automatic power off device 31 and a safety device 32 so as to automatically power off the power supply in a water dry or overheating condition, hence the pot 4 will not air burn or produce excessive pressure at high temperature.

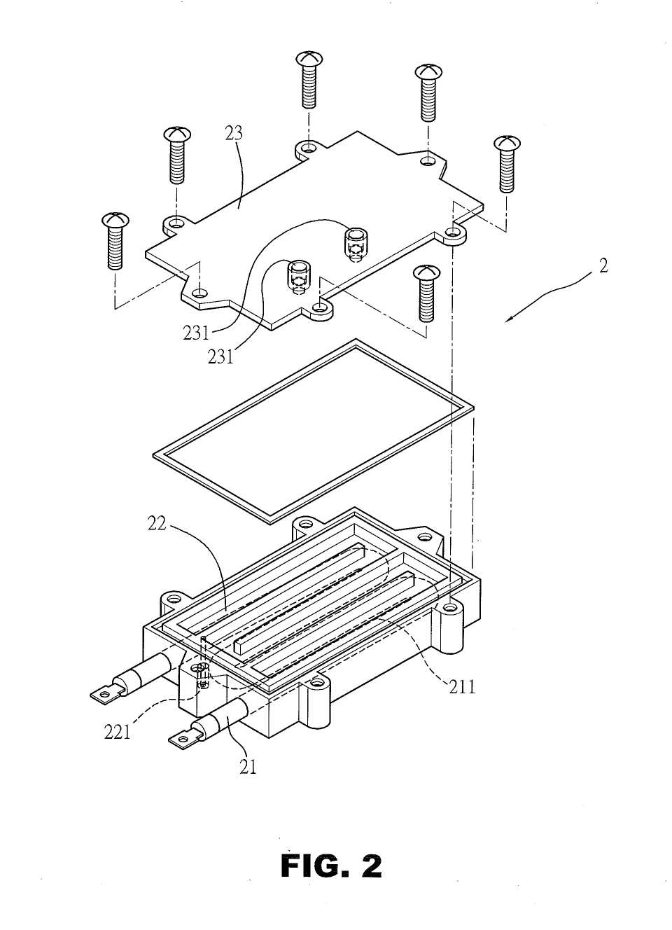

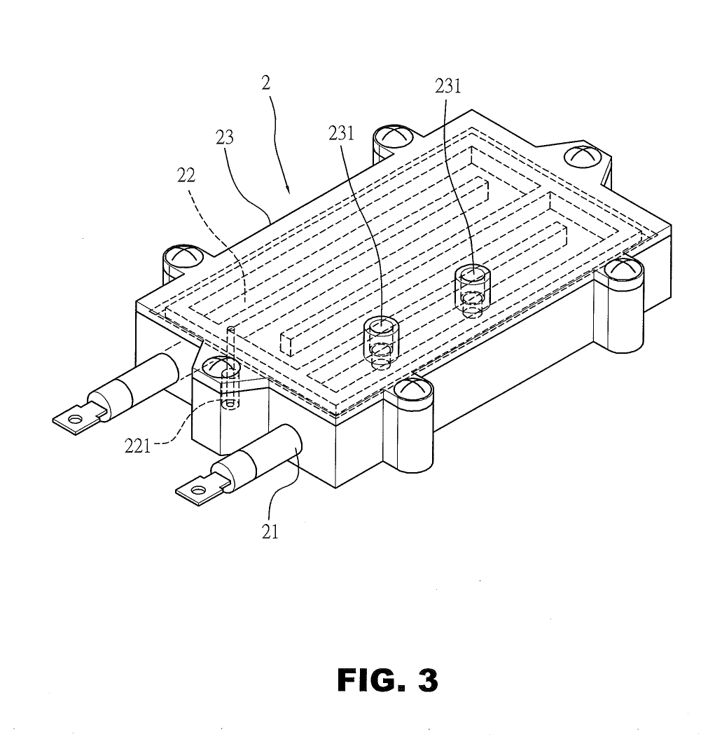

FIG. 2 is a perspective view showing the exploded components of the household electrothermal vaporization heater according to the preferred embodiment of the present invention. The heating body 21 includes a heat tube 211 precast therein and made of thermal conductivity material and a heating channel 22 corresponding to the heat tube 211 and formed in a U shape, the heating channel 22 has an inlet 221 defined on a first end thereof so as to pour the liquid water 11, such that the liquid water 11 flows in the heating channel 22 and is heated by the heat tube 211 quickly so as to convert into the steams, and the steams flow along the heating channel 22 to form the superheated steams, thereafter the cover 23 covers and screws with the heating channel 22 by using a plurality of screw elements, thus preventing the steams from leakage (as shown in FIG. 3). The cover 23 includes a plurality of vapor orifices 231 formed on end edges thereof and corresponding to a second end of the heating channel 22 so as to spray the superheated steams.

FIG. 3 is a perspective view showing the assembly of the household electrothermal vaporization heater according to the preferred embodiment of the present invention. The vaporization heater 2 coverts the liquid water into the superheated steams and sprays the superheated steams onto the food material so as to cook (steam) or heat the food material. In the meantime, the superheated steams produce high temperature to cook (steam) or heat the food material rapidly so as to accelerate cooking (steaming) or heating time and to save power consumption.

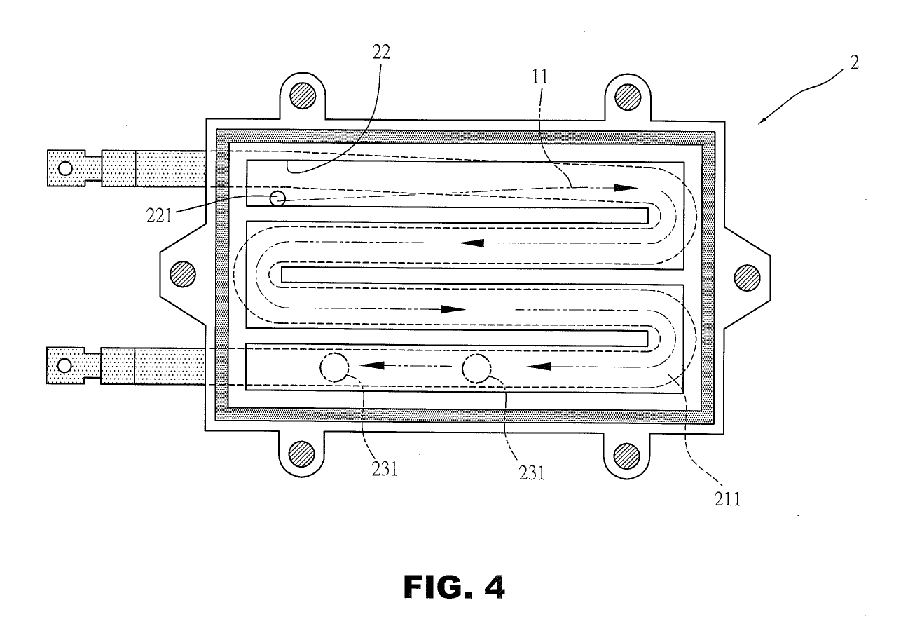

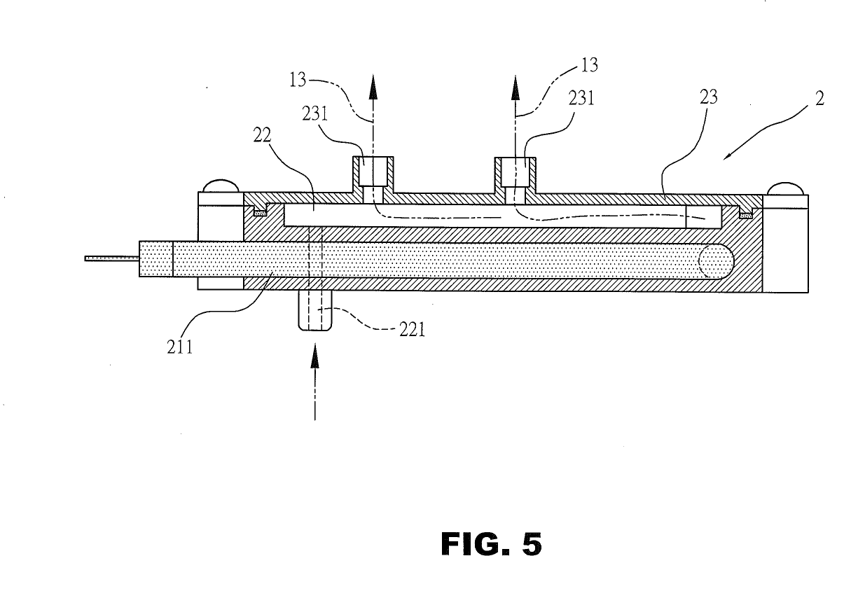

FIG. 4 is a cross sectional view showing the operation of the household electrothermal vaporization heater according to the preferred embodiment of the present invention. The liquid water 11 is poured into the heating channel 22 from the inlet 221, and the heat tube 211 (not shown) is located below the heating channel 22, such that the liquid water 11 is heated by the heat tube 211 to form the steams, and then the steams flow along the heating channel 22 and is heated by the heat tube 211 so as to generate the superheated steams 13 instantly (as illustrated in FIG. 5) at over 300° C., thereafter the superheated steams 13 are sprayed out of the plurality of vapor orifices 231, hence the food material is cooked (steamed) or heated by ways of the superheated steams 13.

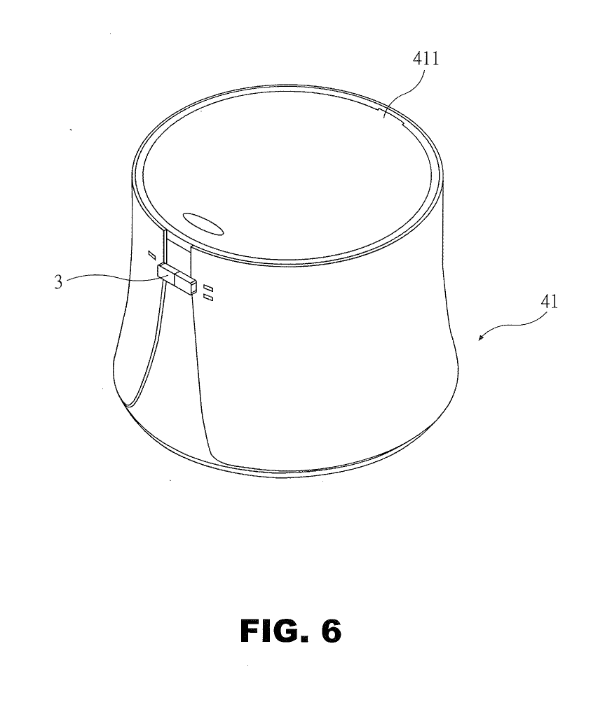

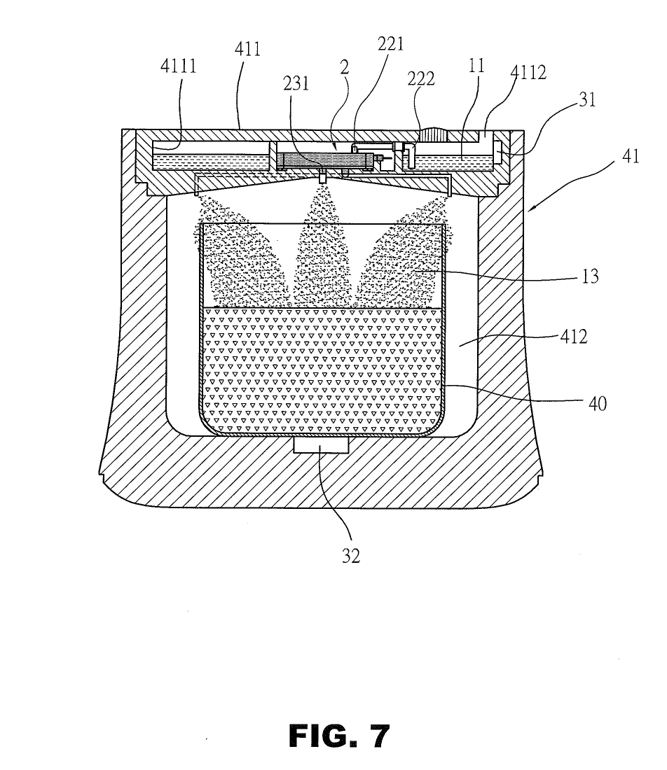

FIG. 6 is a perspective view showing the application of the household electrothermal vaporization heater according to the preferred embodiment of the present invention. A rice cooker 41 includes a lid 411 disposed on a top end thereof and an accommodating chamber 412 (as shown in FIG. 7) for receiving an inner container 40, and the vaporization heater 2 is mounted on the lip 411, such that after starting the power supply 3, the vaporization heater 2 generates heat so that the lid 411 downwardly produces the superheated steams 13, and then the superheated steams 13 sprays onto the food material (rice) so that the rice is heated and steamed, thereby cooking the rice easily and quickly.

FIG. 7 is a cross sectional view showing the application of the household electrothermal vaporization heater according to the preferred embodiment of the present invention. The vaporization heater 2 is fixed on the lip 411, and the lid 411 has a water tank 4111 for storing the liquid water 11 and a feeding orifice 4112 for pouring the liquid water 11 into the water tank 4111. The inlet 221 of the vaporization heater 2 is in connection with a pipe 222 which extends to the water tank 4111, such that the liquid water 11 is drawn into the vaporization heater 2 so as to be heated to produce the superheated steams 13, and then the superheated steams 13 is sprayed onto the food material or the soup in the inner container 40 of the accommodating chamber 412 so as to cook the food material or the soup directly. The water tank 4111 has the automatic power off device 31 secured on one side thereof so that when the liquid water 11 in the water tank 4111 runs out, the rice cooker 41 automatically powers off The safety device 32 is disposed at any position of the rice cooker 41 so as to detect a temperature in the accommodating chamber 412 of the rice cooker 41 and to adjust the temperature; hence the accommodating chamber 412 will not cause overhigh temperature and pressure. It is to be noted that the vaporization heater 2 can be fixed at any position in the accommodating chamber 412 as well.

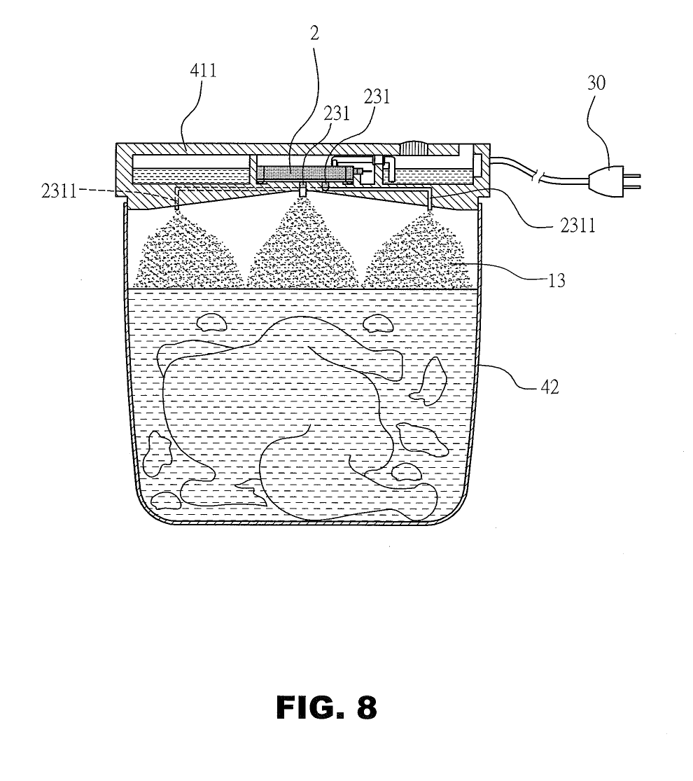

FIG. 8 is another cross sectional view showing the application of the household electrothermal vaporization heater according to the preferred embodiment of the present invention. The lid 411 has the vaporization heater 2 and a power on device 30 for connecting with a socket, wherein the lid 411 has a diameter for matching with a diameter of an opening of a soup pot 42, such that after starting the power supply, the superheated steams 13 are sprayed out of a plurality of spray heads 2311 which are arranged on the plurality of vapor orifices 231 so as to heat the food material in the soup pot 42 quickly.

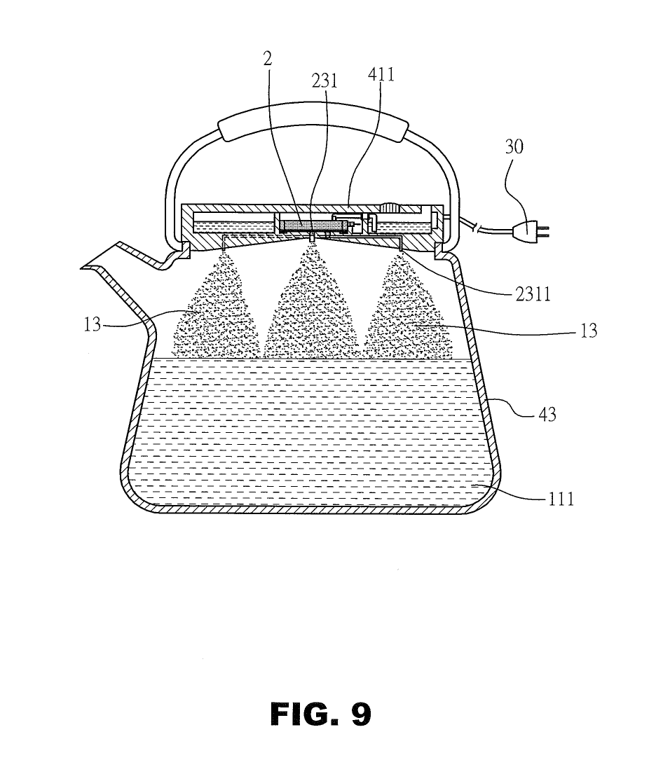

FIG. 9 is also another cross sectional view showing the application of the household electrothermal vaporization heater according to the preferred embodiment of the present invention. A kettle 43 includes a lid 411 covered on a top end thereof The power on device 30 is connected with the socket so as to supply power to the vaporization heater 2, such that the superheated steams 13 are sprayed out of the plurality of spray heads 2311 so as to heat liquid 111 in the kettle 43, thus boiling the liquid 111.

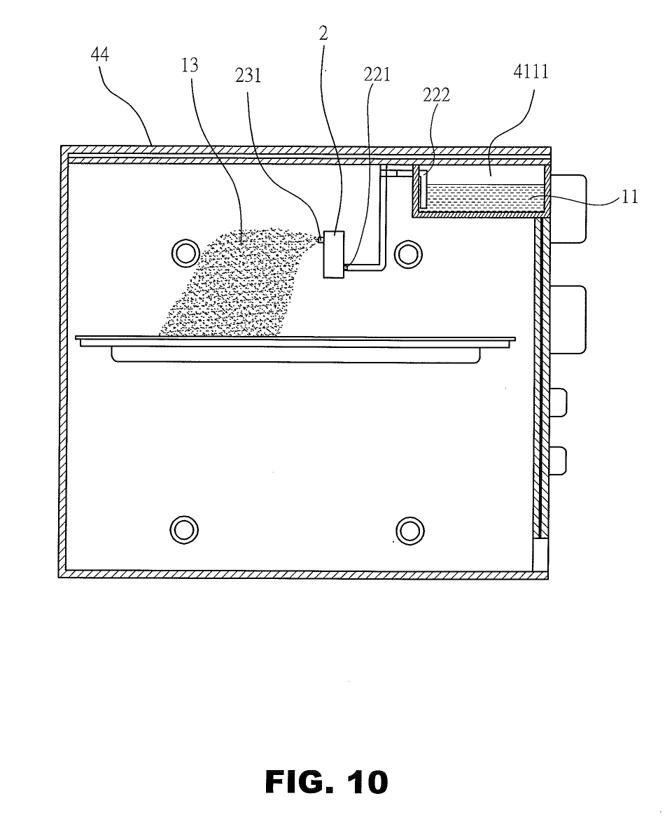

FIG. 10 is still another cross sectional view showing the application of the household electrothermal vaporization heater according to the preferred embodiment of the present invention. An oven 44 includes a water tank 4111 for storing the liquid water 11 and coupling with the pipe 222 of the vaporization heater 2, such that the vaporization heater 2 heats the liquid water 11 in the water tank 4111, and then the liquid water 11 is drawn into the vaporization heater 2 via the pipe 222 so as to produce the superheated steams 13, thereafter the superheated steams 13 are sprayed onto the food material in the oven 44 through the plurality of vapor orifices 231, thus avoiding the food material dry or overroasted.

Thereby, the vaporization heater of the present invention is capable of converting the liquid water into the superheated steams so as to cook the food material or the soup quickly by means of the superheated steams and to maintain the original flavor of the food material. In addition, the vaporization heater is applicable for various cooking utensils, such as the rice cooker, the soup pot, the kettle, and the oven, etc.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A household electrothermal vaporization heater comprising: a heating body and a cover, the heating body including a heat tube precast therein and made of thermal conductivity material and a heating channel corresponding to the heat tube and formed in a U shape, the heating channel having an inlet defined on a first end thereof so as to pour liquid water, such that the liquid water flows in the heating channel and is heated by the heat tube quickly so as to convert into superheated steams, and the cover covers and screws with the heating channel by using a plurality of screw elements, thus preventing steams from leakage; wherein
the cover includes a plurality of vapor orifices formed on end edges thereof and corresponding to a second end of the heating channel so as to spray the superheated steams.

2. A household electrothermal vaporization heater being used to convert liquid water into superheated steams, wherein in a converting process, liquid water is drawn into a vaporization heater, and after starting a power supply, the vaporization heater generates a heat so as to heat the liquid water to produce steams, thereafter the steams are circulated to generate the superheated steams, and a temperature of the superheated steams is more than 300° C., then the superheated steams are sprayed out of a pot to cook/steam food material and to maintain original flavor of the food material; wherein
the pot includes an automatic power off device and a safety device so as to automatically power off the power supply in a water dry or overheating condition, such that the pot does not air burn or produce excessive pressure at high temperature.

3. The household electrothermal vaporization heater as claimed in claim 1, wherein the plurality of vapor orifices have a plurality of spray heads arranged thereon so as to spray the superheated steams.

4. The household electrothermal vaporization heater as claimed in claim 1, wherein the vaporization heater is fixed at any position in the accommodating chamber or on a lid.

5. The household electrothermal vaporization heater as claimed in claim 4, wherein the accommodating chamber is any one of a pot, a kettle and an oven.

6. The household electrothermal vaporization heater as claimed in claim 4, wherein the accommodating chamber includes an automatic power off device and a safety device.
